(19) United States
(12) Patent Application Publication
(10) Pub. No.: US 2009/0223063 A1
(43) Pub. Date: Sep. 10, 2009

(54) DUAL BLADED UTILITY KNIFE

(76) Inventors: Todd E. Hallquist, Jamestown, NY (US); Gary B. Lynn, Frewsburg, NY (US)

Correspondence Address: THE BILICKI LAW FIRM, PC, 1285 North Main Street, JAMESTOWN, NY, 14701, US

(21) Appl. No.: 12/045,091

(22) Filed: Mar. 10, 2008

(51) Int. Cl. B26B 5/00; B26B 1/08

(52) U.S. Cl. 30/162

(57) ABSTRACT

A dual bladed utility knife is provided. The utility knife has a housing with a longitudinal direction and a transverse direction. The housing further has a first end. First and second blades are included that are capable of extending from the first end. An actuator is present that is capable of positioning the first blade and second blade into different positions with respect to the housing. The actuator has a button that may be capable of being moved in the longitudinal direction and the transverse direction.

### BRIEF DESCRIPTION OF THE DRAWINGS

FIG. 1 is a perspective view of a utility knife in accordance with one exemplary embodiment.

FIG. 2 is an exploded assembly view of the utility knife of FIG. 1.

FIG. 3 is a perspective view of a portion of the utility knife of FIG. 1 showing the position of both blades when contained in the housing.

FIG. 4 is a perspective view of a portion of the utility knife of FIG. 1 showing the position of the first blade when it extends from the housing.

FIG. 5 is a perspective view of a portion of the utility knife of FIG. 1 showing the position of the second blade when it extends from the housing.

FIG. 6 is a perspective view of the utility knife of FIG. 1 in which a first blade detachment member is actuated to effect removal of the first blade.

FIG. 7 is a perspective view of the utility knife of FIG. 1 in which a second blade detachment member is actuated to effect removal of the second blade.

### DETAILED DESCRIPTION OF EMBODIMENTS OF THE INVENTION

An exemplary embodiment of the present invention provides for a dual bladed utility knife 10 with a thumb slide button 28. The arrangement of utility knife 10 enables a user to extend and retract blades 22 and 24 with one hand, without having to touch the blades 22 or 24. Further, the utility knife 10 eliminates the need to carry more than one knife should various types of blades 22 and 24 be desired, and the utility knife 10 may be arranged so as not to require use of both hands to change the blades 22 and 24. Reference will now be made in detail to the embodiments of the invention, examples of which are illustrated in the drawings.

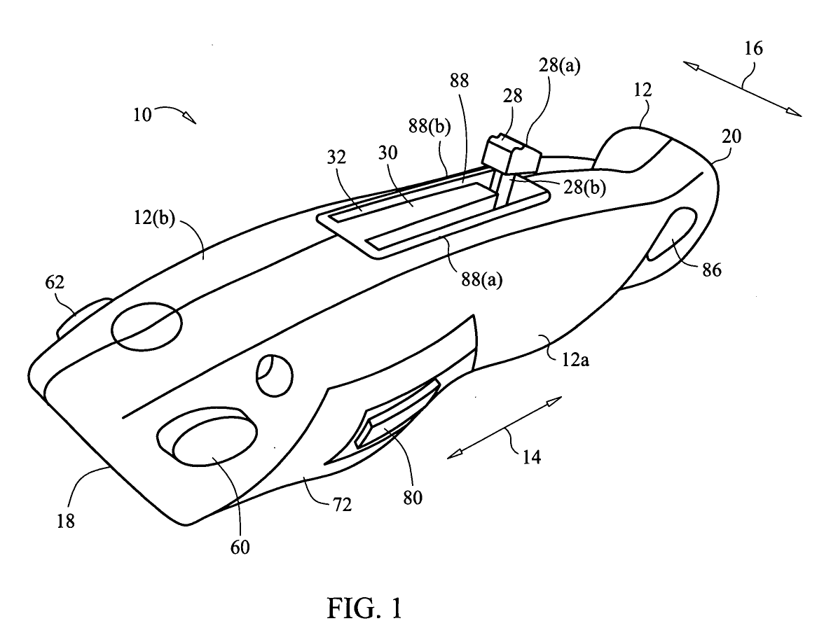

FIG. 1 illustrates a first embodiment of a utility knife 10, in a non-operational position. An opening 88 may be defined on the top of a housing 12 of the utility knife 10. Opening 88 may be along the length of housing 12. A button 28 is present and has a portion that may be disposed into the housing 12 through the opening 88. The button 28 may be capable of sliding along a longitudinal direction 14 of the housing 12. Further, the button 28 may be capable of moving along a transverse direction 16 of housing 12. The button 28 may be pushed by the thumb of the user to slide with respect to the housing 12 in the longitudinal direction 14 and the transverse direction 16.

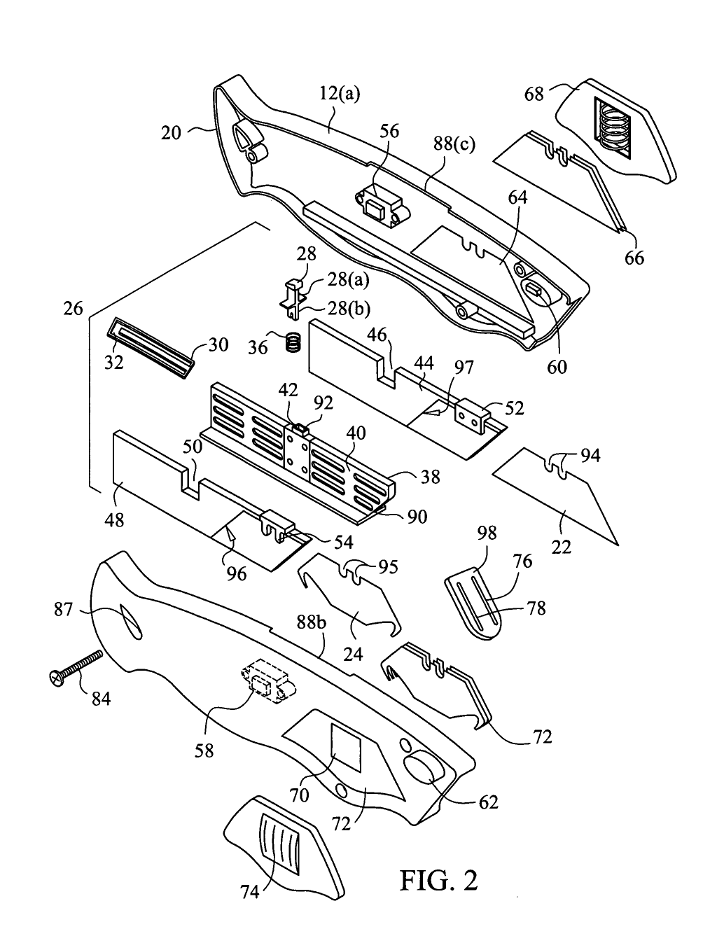

Referring to FIG. 2, the housing 12 of the utility knife 10 has a left housing-half 12(a) and a right housing-half 12(b). Both the left housing-half 12(a) and the right housing-half 12(b) have a convex inner side and a concave outer side. The opening 88 is a combination of a left opening-half 88(a) and a right opening-half 88(b). The left opening-half 88(a) is defined on the top of the left housing-half 12(a), and the right opening-half 88(b) is defined on the top of the right housing-half 12(b). The left housing-half 12(a) may be coupled with the right housing-half 12(b) such that the concave inner side of the left housing-half 12(a) faces the concave inner side of the right housing-half 12(b). As the left opening-half 88(a), on the top of the left housing-half 12(a) is aligned with the right opening-half 88(b), on the top of the right housing-half 12(b), the opening 88 is defined on the top of housing 12, as illustrated in FIG. 1. The left housing-half 12(a) may have an aperture 86 which may be aligned with an aperture 87 present on the right housing-half 12(b). A threaded screw 84, or the like, may be extended through the aligned apertures 86 and 87 to couple the left housing-half 12(a) with the right housing-half 12(b). The apertures 86 and 87 may be present near a second end 20 of the housing 12, or anywhere else along the length of the utility knife 10 to securely couple the left housing-half 12(a) with the right housing-half 12(b). Additional screws and apertures may also be present at other locations along the housing 12 in order to further secure the left housing-half 12(a) with the right housing-half 12(b). Other coupling means may be employed for coupling the left housing-half 12(a) with the right housing-half 12(b). For example a U-shaped clamp, adhesives, magnetic fasteners, or other mechanical fasteners may be employed in accordance with other exemplary embodiments.

With reference to FIG. 2, a first blade 22 can be extended and retracted from the housing 12 of the utility knife 10 through a blade-slot 76 present at a first end 18 of the housing 12. Alternatingly, a second blade 24, can be extended and retracted from the housing 12 of the utility knife 10 through a blade-slot 78 present at the first end 18 of the housing 12. The first blade 22 may have, for example, a straight cutting surface. Additionally, the second blade 24 may have a hook-shaped cutting surface. The first blade 22 and second blade 24 may have varying shapes in order to provide various cutting capabilities as desired. Further, in alternative embodiments, the profiles of the first blade 22 and the second blade 24 may be similar.

To operate the utility knife 10, an actuator 26 shown in FIG. 2, may be utilized. As illustrated in FIG. 2, the actuator 26 may be an assembly that includes the button 28 which is disposed into the housing 12 through the opening 88, a track 30 on which the button 28 may slide, a sliding member 38, a first blade engagement member 44, and a second blade engagement member 48.

As seen in FIG. 2, the track 30 may have a slot 32 that is wider at one end so as to accommodate the button 28. The button 28 may have an upper block 28(a) and a lower stem 28(b). A spring 36 may be coiled around the lower stem 28(b). The sliding member 38 may include a sliding member body 40 which may be generally rectangular in shape with a slant side 90. A button engagement member 42 may also be present on the sliding member 38 which may be cuboidal in nature. The button engagement member 42 may be removably attached at the center of the sliding member body 40. The sliding member 38 is placed in the housing 12, along the length of the housing 12, and the button engagement member 42 is capable of pivoting along the transverse direction 16. The button engagement member 42 may have a cavity at the top 92 to matingly receive the lower stem 28(b) of the button 28.

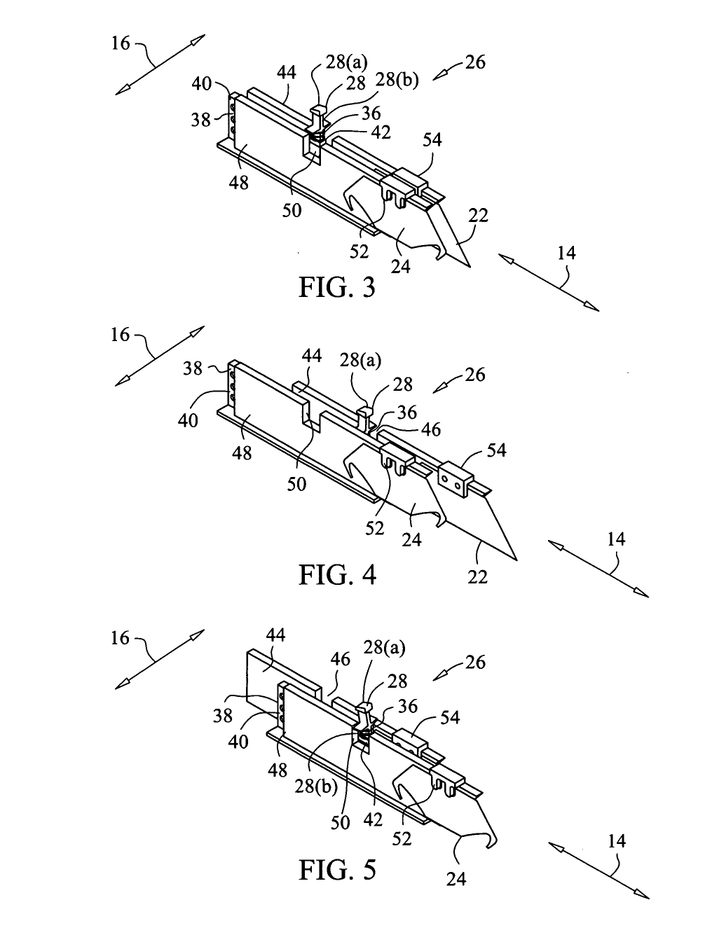

Referring to FIG. 3, on one side of the sliding member body 40, the first blade engagement member 44 may be positioned to carry the first blade 22. On the opposite side of the sliding member body 40, the second blade engagement member 48 may be positioned to carry the second blade 24. The first blade engagement member 44 may have a first blade engagement member recess 46 formed at its center. The first blade engagement member 44 may be provided with a ledge 96 on the front surface which defines the position for placing the first blade 22. For accurate positioning of the first blade 22, a pair of projections 52 may protrude from the first blade engagement member 44. The projections 52 on the first blade engagement member 44 may be sized to securely fit in a pair of notches 94 formed on the first blade 22 illustrated in FIG. 3. The projections 52 prevent displacement of the first blade 22 from its defined position on the first blade engagement member 44. The projections 52 may be capable of being depressed towards the first blade engagement member 44 so that the first blade 22 becomes free to slide along the length of the first blade engagement member 44.

The second blade engagement member 48, positioned on the opposite side of the sliding member body 40, carries the second blade 24. The second blade engagement member 48 may have a second blade engagement member recess 50 formed at its center. The second blade engagement member 48 may be provided with a ledge 97 on the front surface which defines a position for placing the second blade 24. For accurate positioning of the second blade 24, a pair of projections 54 may protrude from the second blade engagement member 48. The projections 54 on the second blade engagement member 48 may be sized to securely fit in a pair of notches 95 formed on the second blade 24 illustrated in FIG. 3. The projections 54 prevent displacement of the second blade 24 from its defined position on the second blade engagement member 48. The projections 54 may be capable of being depressed towards the second blade engagement member 48 so that the second blade 24 becomes free to slide along the length of the second blade engagement member 48.

The first blade engagement member 44 and the second blade engagement member 48 may be positioned on opposite sides of the sliding member body 40. The front surface of the first blade engagement member 44, which has the pair of notches 94 and the ledge 96 may not face the sliding member body 40. However, other embodiments are possible in which the front surface may in fact face the sliding member body 40. The first blade engagement member recess 46 can be aligned with the button engagement member 42. Similarly, the front surface of the second blade engagement member 48 that has the pair of notches 95 and the ledge 97 does not face the sliding member body 40. The second blade engagement member recess 50 can be aligned with the button engagement member 42. With this arrangement, the first blade engagement member recess 46, the button engagement member 42 of the sliding member 38 and the second blade engagement member recess 50 are aligned parallel to each other in subsequent order. This arrangement is illustrated with reference to FIG. 3.

The actuator 26 is positioned in the housing 12. Referring to FIG. 2, the track 30 can be positioned on a pair of arched mounting posts (not shown) provided in the left housing-half 12(a) beneath the opening 88 in the housing 12. The button 28 can be placed on track 30 so that the lower-stem 28(b) passes through the slot 32 and is thus disposed into housing 12. The upper-block 28(a) remains on top of the housing 12. A biasing member 56 may be provided on the concave side of the left housing-half 12(a). The biasing member 56 may be a push-button in accordance with certain exemplary embodiments. The first blade engagement member 44 can be positioned along the length of the left housing-half 12(a) in contact with the biasing member 56. The first blade engagement member 44 is positioned so that the biasing member 56 lies in the first blade engagement member recess 46. The biasing member 56 may be sized so that it fits in the first blade engagement member recess 46. When the biasing member 56 is not depressed, it prevents sliding of the first blade engagement member 44 in the longitudinal direction 14. The biasing member 56 may be depressed, so that the first blade engagement member 44 is free to slide along the length of the housing 12 in the longitudinal direction 14. A user may push the button 28 in the transverse direction 16 so as to be inserted into the first blade engagement member recess 50 to depress the biasing member 56 to allow for movement in the longitudinal direction 14.

As explained above, next to the first blade engagement member 44, the sliding member 38 is positioned. On the opposite side of the sliding member 38, the second blade engagement member 48 is positioned. A first blade storage area 64 may be present in the left housing-half 12(a) closer to the first end 18 for use in storing the first blade 22. Access to the first blade storage area 64 may be gained by removing a cover 80 present on the convex outer side of the left housing-half 12(a) as illustrated in FIG. 1. A first biasing member 68 may be present in the first blade storage area 64 on the concave inner side of the left housing-half 12(a). The first biasing member 68 may have a spring arranged to urge the first blade 22 stored in the first blade storage area 64 towards the first blade engagement member 44. Urging of the first blade 22 towards the first blade engagement member 44 causes the first blade 22 to be captured by the first blade engagement member 44.

Referring to FIG. 3, a biasing member 58 may be provided on the concave side of the right housing-half 12(b). The biasing member 58 may be a push-button in accordance with one exemplary embodiment. The second blade engagement member 48 can be positioned next to sliding member body 40 in contact with the biasing member 58. The second blade engagement member 48 is positioned such that the biasing member 58 lies in the second blade engagement member recess 50. When the biasing member 58 is not depressed, it prevents sliding of the second blade engagement member 48 along the length of the right housing-half 12(b) in the longitudinal direction 14. The biasing member 58 may be depressed so that the second blade engagement member 48 becomes free to slide along the length of the right housing-half 12(b). The biasing member 58 may be depressed upon a user pushing the button 28 in the transverse direction 16 so that the spring force of the biasing member 58 is overcome.

A second blade storage area 70 for storing the second blade 24 may be provided on the concave inner side of right housing-half 12(b) proximate to the first end 18. A cover 82 illustrated in FIG. 3, may be removed to gain access to the second blade storage area 70. The right housing-half 12(b) may define a blade-slot 76 and a blade-slot 78 defined in a lid 98 present at the first end 18 of the right housing-half 12(b). The lid 98 may be removably or fixedly attached at the first end 18. Upon operation, the first blade 22 and the second blade 24 extend out from the blade-slots 76 and 78, respectively.

FIG. 4 shows extension of the first blade 22 from the housing 12. This action involves co-operation between the first blade engagement member 44, the sliding member 38. Depression of the button 28 causes a spring 36, which is wound around the lower-stem 28(b) of the button 28, to become compressed. The lower-stem 28(b) of the button 28 is inserted deeper into the button engagement member 42. The button 28 may be depressed and pushed along the transverse direction 16, towards the left housing half 12(a), to engage the button engagement member 42 with the first blade engagement member recess 46. This action functions to depress the biasing member 56 present in the left housing-half 12(a). Thus, as the button 28 slides along the longitudinal direction 14 towards the first-end 18 of the housing 12, the first blade engagement member 44 also slides towards first end 18. The first blade 22, carried by the first blade engagement member 44, extends out from the blade-slot 76 present at the first end 18 of the housing 12. The second blade engagement member 48 is secured inside the housing 12 by the biasing member 58. The first blade 22 may be retracted into the housing 12 by depressing the button 28 and sliding it in the opposite direction towards the second end 20 along the longitudinal direction 14.

The button 28, which is in a neutral position in FIG. 3, may be used to extend and retract the first blade 22 and the second blade 24 from the utility knife 10. Referring to FIG. 5, for extending the second blade 24, the button 28 may be depressed and pushed along the transverse direction 16, towards the right housing-half 12(b). This also causes the track 30 to move along the arched mounting posts (not shown) towards the right housing-half 12(b). The biasing member 58 is compressed out of the second blade engagement member recess 50 by the button button engagement member 42 of the button 28 to allow movement in the longitudinal direction 14. Thereafter, the button 28, in the depressed position, is slid in the longitudinal direction 14, towards the first end 18 of the housing 12, thus extending the second blade 24 from the housing 12.

Movement of the button 28 in the transverse direction 16 towards the right housing-half 12(b) causes the button engagement member 42 to pivot towards the right housing-half 12(b) and become inserted into the second blade engagement member recess 50. The second blade engagement member recess 50 may be sized to receive the button engagement member 42. Due to the movement of the button engagement member 42 towards the right housing-half 12(b), the biasing member 58 becomes depressed and the second blade engagement member 48 becomes free to slide along the length of the housing 12 in the longitudinal direction 14. Thus, as the button 28, in the depressed position, is slid on the track 30 in the longitudinal direction 14, the second blade engagement member 48 is slid along with the sliding member 38 in the same direction. The second blade engagement member 48 is carried along with the sliding member 38 in the longitudinal direction 14 towards the first end 18 of the housing 12. When this occurs, the first blade engagement member 44 stays securely positioned inside the housing 12. Sliding motion of the first blade engagement member 44 is prevented by the biasing member 56. The second blade engagement member 48, carrying the second blade 24, thus slides in the longitudinal direction 14 towards the first end 18 of the housing 12. The second blade 24 extends out of the housing 12 from the blade-slot 78 present at the first end 18. To retract the second blade 24, the button 28 may be depressed and slid towards the second-end 20 in the opposite direction in the longitudinal direction 14. This causes the second blade engagement member 48, carrying the second blade 24, to slide towards the second-end 20 of the housing 12. Thus, the second-blade 24 is retracted into the housing 12.

The actuator 26 may be arranged so that it does not allow the simultaneous extension of the first blade 22 and the second blade 24 from the housing 12 of the utility knife 10. Further, the actuator 26 may be arranged so that it is capable of extending and retracting both the first blade 22 and the second blade 24. However, it is to be understood that other arrangements are possible in which more than one actuator 26 can be present. A single actuator 26 may thus be employed that allows blades 22 and 24, that may be configured differently or the same as one another, to be extended and retracted from the housing 12

Whenever there is a need for blade replacement, the first blade 22 or the second blade 24 may be removed from the housing 12. This can be accomplished without removing the covers 80 or 82 to access the first blade storage area 64 or the second blade storage area 70, respectively.

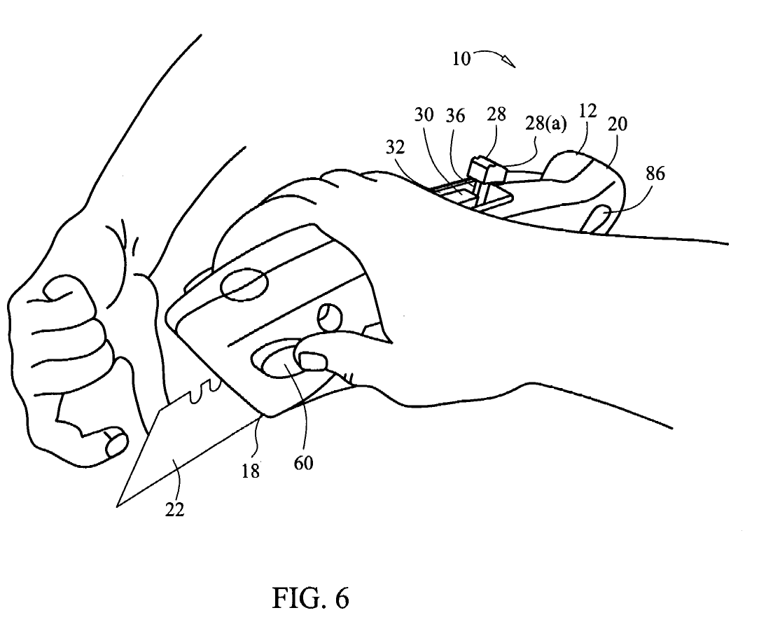

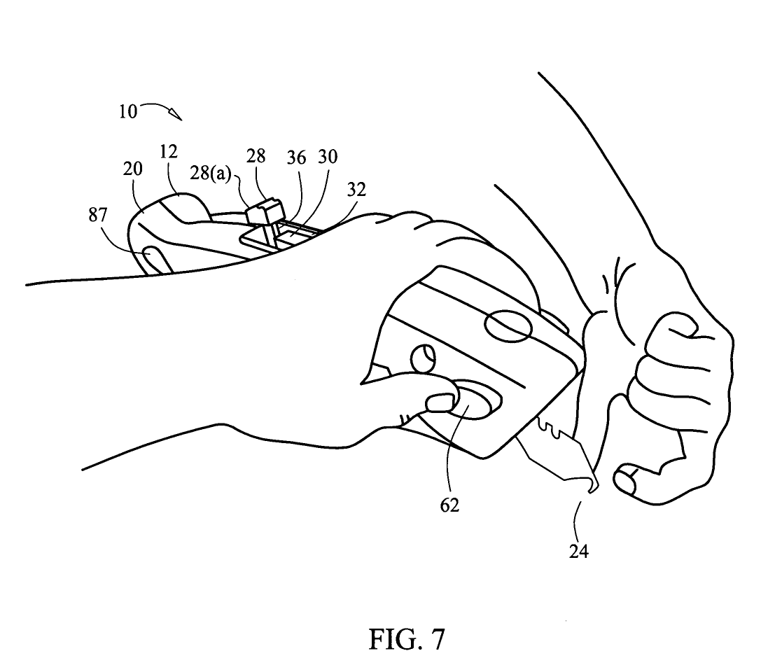

As shown with reference to FIGS. 6 and 7, the first blade 22 may extend out from the housing 12. In order to detach the first blade 22, a first blade detachment member 60, which may be present on the left housing-half 12(a) at the position of the eye of the shark, may be actuated in the transverse direction 16, towards the housing 12 to depress the projections 52 present on the first blade engagement member 44. Consequently, the first blade 22 disengages from the first blade engagement member 44 and can be pulled out to be completely removed from the housing 12. Thereafter, the first blade detachment member 60 may again be actuated in the transverse direction 16 towards the housing 12, and another first blade 22 may be inserted from the blade-slot 76 present at the first end 18 of the right housing-half 12(b).

A second blade detachment member 62, illustrated in FIGS. 6 and 7 may be present on the right housing-half 12(b) at the position of the eye of the shark. A lower portion of the second blade detachment member 62 is disposed inside the housing 12. When the second blade 24 extends out from the housing 12, the second blade detachment member 62 may be actuated along the transverse direction 16, towards the housing 12. Consequently, the projections 54 protruding from the second blade engagement member 48 are depressed, which disengages the second blade 24. The second blade 24 can then be pulled out and completely removed from the housing 12. Another second blade 24 may be fed into the housing 12. In one embodiment, the second blade detachment member 62 can be actuated along the same direction and another second blade 24 can be inserted into the blade-slot 78 present at the first end 18 of the right housing-half 12(b).

The described mechanism of removal and insertion of first blade 22 and the second blade 24 may be used to extend the life of the first blade 22 and the second blade 24. Whenever the cutting edge of the either of the first blade 22 or the second blade 24 becomes blunt, the blade 22 or 24 can simply be removed, turned over and then inserted so that the other edge of the blade 22 or 24 can be used. In an alternate embodiment, the first blade detachment member 60 and the second blade detachment member 62 may not be present, wherein replacing the first blade 22 and the second blade 24 requires the user to open the respective covers 80 and 82 present on the outer convex side of the housing 12.

To save the user the trouble of replacing the first blade 22 and the second blade 24, an alternate embodiment may be used that allows more than one first blade 22 and more than one second blade 24 to be stored in the housing 12. FIG. 2 illustrates a plurality 66 of first blades 22 and a plurality 72 of second blades 24. The plurality 66 of the first blades 22 may be stored in the first blade storage area 64 present in the left housing-half 12(a). The plurality 66 of the first blade 22 may be positioned over the first biasing member 68 present in the left housing-half 12(a). The plurality 72 of the second blades 24 may be stored in the second blade storage area 70, present in the right housing-half 12(b). The plurality 72 of the second blades 24 may be positioned over the second biasing member 74 present in the right housing-half 12(b).

The first-blade 22 may be removed from the housing 12 by the process mentioned above. Consequently, the first biasing member 68 urges a subsequent first blade 22 of the plurality 66 of first blades 22 into engagement with the first blade engagement member 44. Similarly, if required, the second bade 24 may be removed from the housing 12 resulting in a subsequent second blade 24 of the plurality 72 of the second blades 24 being urged into engagement with the second blade engagement member 48 by the second biasing member 74. In an additional alternate embodiment, there may be another first blade storage area 64 and another second blade storage area 70 present near the second end 20 of the housing 12 for purposes of storing extra first blades 22 and extra second blades 24.

An additional alternative exemplary embodiment of the utility knife 10 is explained hereinafter. This additional embodiment is similar to a previously mentioned embodiment except that the first blade 22 and the second blade 24 may be extended simultaneously from the housing 12 of utility knife 10. To achieve this feature, the first blade engagement member 44 and the second blade engagement member 48 may be fixedly or removably attached at the opposite sides of the sliding member body 40. This arrangement eliminates the biasing members 56 and 58 present in the housing-halves 12(a) and 12(b), respectively. The present embodiment does not include movement of the button 28 along the transverse direction 16. The button 28, when in the neutral position, may only be slid in the longitudinal direction 14 towards the first end 18 of the housing 12. This movement of button 28 causes the sliding member 38 to slide along with the first blade engagement member 44 and the second blade engagement member 48. The first blade 22 and the second blade 24 are positioned on the first blade engagement member 44 and the second blade engagement member 48, respectively. Consequently, the first blade 22 and the second blade 24 simultaneously extend from their respective blade-slots 76 and 78 present at first end 18 of housing 12. This exemplary embodiment may find utility in situations which require both the blades 22 and 24 to operate simultaneously. Although described as being capable of simultaneously extending from the housing 12, it is to be understood that various exemplary embodiments exist in which the blades 22 and 24 can only extend one at a time from the housing 12 as previously discussed. In this regard, the actuator 26 is configured so that only one of the blades 22 or 24 can be extended as previously mentioned.

Additional modifications to the above mentioned embodiments are possible to yield still further embodiments. For example, the utility knife 10 may employ a mechanism which allows the extension of the first blade 22 and the second blade 24 from the second end 20 as well as from the first end 18 of the housing 12. In such a mechanism, the ledge 96 as well as the projections 52 and the ledge 97 as well as the projections 54 may be formed on both the ends of the first blade engagement member 44 and the second blade engagement member 48, respectively. The first blade storage area 64 and the second blade storage area 70 may be present at both ends of the housing 12 which may be accessed by removing the covers 80 and 82. The first blade 22 and the second blade 24 may be positioned on the opposite ends of their respective blade engagement members 44 and 46. In this regard, the first blade 22 and the second blade 24 can be located in the first blade storage area 64 and the second blade storage area 70 defined at the second end 20 of the housing 12. The button 28 may be placed at the longitudinal center of the slot 32 to achieve the non-operational neutral position. The button 28 may be moved along the transverse direction 16 towards either the left housing-half 12(a) or the right housing-half 12(b). Next, the button 28 can be moved along the longitudinal direction 14 towards the second end 20 of the housing 12. Consequently, the respective blade 22 or blade 24 is extended from the respective blade-slot 76 or 78 present at the second end 20 of the housing 12. Simultaneous extension of first blade 22 and the second blade 24 from the second end 20 may be achieved if the first blade engagement member 44, the sliding member 38 and the second blade engagement member 48 are fixedly or removably attached to each other as previously described.

An additional exemplary embodiment of the utility knife 10 may exist in which the first blade 22 and the second blade 24 may be simultaneously extended from the first end 18 and the second end 20. To achieve this arrangement, a pair of actuators 26 may be present. The actuators 26 can be connected in back-to-back fashion. It is to be understood that the actuators 26 can be configured as in a previously discussed embodiment and may be configured the same as one another or different from one another. This embodiment allows the two actuators 26 to work independent of one another. Hence any blade 22 or 24 from any end 18 or 20 may be extended from the housing 12 without affecting the movement or position of the other blades 22 or 24.

While the embodiments of the present invention have been described, it is to be understood that the claimed invention is not to be limited in scope to the aforementioned and described embodiments.

What is claimed is:

1. A utility knife, comprising:
a housing having a longitudinal direction and a transverse direction, wherein the housing has a first end and a second end longitudinally disposed from one another;
a first blade, wherein the first blade is capable of being located completely inside of the housing, and wherein the first blade is capable of extending from the first end of the housing;
a second blade, wherein the second blade is capable of being located completely inside of the housing, and wherein the second blade is capable of extending from the first end of the housing; and
an actuator, wherein the actuator is capable of positioning the first blade between the position completely inside of the housing and the position extending from the first end of the housing, wherein the actuator is capable of positioning the second blade between the position completely inside of the housing and the position extending from the first end of the housing, wherein the actuator is configured such that the first blade and the second blade are not capable of both being simultaneously located at their respective positions extending from the first end of the housing.

2. The utility knife as set forth in claim 1, wherein the first blade has a straight edge, and wherein the second blade has a hooked edge.

3. The utility knife as set forth in claim 1, wherein the actuator has a button that is capable of being moved in the transverse direction of the housing, and wherein the button is capable of being moved in the longitudinal direction of the housing.

4. The utility knife as set forth in claim 3, wherein the actuator has a track that defines a slot that extends in the longitudinal direction, wherein the button is disposed in the slot and is capable of being moved along the slot, wherein the track is capable of being moved in the transverse direction with respect to the housing.

5. The utility knife as set forth in claim 4, wherein the actuator has a sliding member that has a sliding member body and a button engagement member, wherein the button engages the button engagement member, wherein the actuator has a first blade engagement member that carries the first blade and defines a first blade engagement member recess, wherein the actuator has a second blade engagement member that carries the second blade and defines a second blade engagement member recess, wherein the first blade engagement member and the second blade engagement member are located on opposite sides of the sliding member body, wherein the button engagement member is capable of being disposed in the first blade engagement member recess such that the sliding member and the first blade engagement member are capable of being moved in the longitudinal direction with respect to the housing while the second blade engagement member remains stationary in the longitudinal direction with respect to the housing, wherein the button engagement member is capable of being disposed in the second blade engagement member recess such that the sliding member and the second blade engagement member are capable of being moved in the longitudinal direction with respect to the housing while the first blade engagement member remains stationary in the longitudinal direction with respect to the housing.

6. The utility knife as set forth in claim 1, further comprising:
a first blade detachment member carried by the housing and capable of being actuated in the transverse direction so as to disengage the first blade such that the first blade is capable of being completely removed from the housing; and
a second blade detachment member carried by the housing and capable of being actuated in the transverse direction so as to disengage the second blade such that the second blade is capable of being completely removed from the housing.

7. The utility knife as set forth in claim 1, wherein the housing defines a first blade storage area configured for storing a plurality of first blades, wherein the housing defines a second blade storage area configured for storing a plurality of second blades, and further comprising:
a first biasing member carried by the housing and configured for urging a subsequent one of the plurality of first blades into engagement with the actuator upon complete removal of the first blade from the housing; and
a second biasing member carried by the housing and configured for urging a subsequent one of the plurality of second blades into engagement with the actuator upon complete removal of the second blade from the housing.

8. A utility knife, comprising:
a housing having a first end;
a first blade;
a second blade;
an actuator configured for simultaneously carrying the first blade and the second blade, wherein the actuator is configured for positioning the first blade so as to extend from the first end of the housing, and wherein the actuator is configured for positioning the second blade so as to extend from the first end of the housing.

9. The utility knife as set forth in claim 8, wherein the actuator is configured for positioning the first blade so as to be completely retained within the housing, wherein the actuator is configured for positioning the second blade so as to be completely retained within the housing, wherein the actuator is configured such that the first blade and the second blade are not capable of both being simultaneously positioned so as to extend from the first end of the housing.

10. The utility knife as set forth in claim 8, wherein the first blade has a straight edge, and wherein the second blade has a hooked edge.

11. The utility knife as set forth in claim 8, wherein the actuator has a button that is capable of being moved in a transverse direction and in a longitudinal direction, wherein the actuator has a track that defines a slot that extends in the longitudinal direction, wherein the button is disposed in the slot and is capable of being moved along the slot, wherein the track is capable of being moved in the transverse direction.

12. The utility knife as set forth in claim 8, wherein the actuator has a sliding member, wherein the actuator has a first blade engagement member that carries the first blade and defines a first blade engagement member recess, wherein the actuator has a second blade engagement member that carries the second blade and defines a second blade engagement member recess, wherein the first blade engagement member and the second blade engagement member are located on opposite sides of the sliding member.

13. The utility knife as set forth in claim 12, wherein a portion of the sliding member is capable of being disposed in the first blade engagement member recess such that the sliding member and the first blade engagement member are capable of being moved in the longitudinal direction, wherein a portion of the sliding member is capable of being disposed in the second blade engagement member recess such that the sliding member and the second blade engagement member are capable of being moved in the longitudinal direction.

14. The utility knife as set forth in claim 8, further comprising:
a first blade detachment member configured for disengaging the first blade from the actuator such that the first blade is no longer carried by the actuator; and
a second blade detachment member configured for disengaging the second blade from the actuator such that the second blade is no longer carried by the actuator.

15. The utility knife as set forth in claim 8, further comprising:
a plurality of blades configured the same as the first blade;
a plurality of blades configured the same as the second blade;
a first biasing member carried by the housing and configured for urging one of the plurality of blades configured the same as the first blade into engagement with the actuator so as to be carried by the actuator upon removal of the first blade from the actuator; and
a second biasing member carried by the housing and configured for urging one of the plurality of blades configured the same as the second blade into engagement with the actuator so as to be carried by the actuator upon removal of the second blade from the actuator.

16. A utility knife, comprising:
a housing having a longitudinal direction and a transverse direction, wherein the housing has a first end;
a first blade capable of extending from the first end of the housing;
a second blade capable of extending from the first end of the housing; and
an actuator capable of positioning the first blade and the second blade into different positions with respect to the housing, wherein the actuator has a button that is capable of being moved in the longitudinal direction and the transverse direction.

17. The utility knife as set forth in claim 16, wherein the actuator has a track that defines a slot that extends in the longitudinal direction, wherein the button is disposed in the slot and is capable of being moved along the slot so as to move in the longitudinal direction, wherein the track is capable of being moved in the transverse direction such that the button is moved in the transverse direction.

18. The utility knife as set forth in claim 17, wherein the actuator has a sliding member that has a sliding member body and a button engagement member, wherein the button engages the button engagement member, wherein the actuator has a first blade engagement member that carries the first blade, wherein the actuator has a second blade engagement member that carries the second blade, wherein the first blade engagement member and the second blade engagement member are located on opposite sides of the sliding member body.

19. The utility knife as set forth in claim 18, wherein the first blade engagement member defines a first blade engagement member recess, wherein the second blade engagement member defines a second blade engagement member recess, wherein the button engagement member is capable of being disposed in the first blade engagement member recess such that the sliding member and the first blade engagement member are capable of being moved in the longitudinal direction while the second blade engagement member remains stationary in the longitudinal direction, wherein the button engagement member is capable of being disposed in the second blade engagement member recess such that the sliding member and the second blade engagement member are capable of being moved in the longitudinal direction while the first blade engagement member remains stationary in the longitudinal direction.

20. The utility knife as set forth in claim 16, wherein the first blade has a straight edge, and wherein the second blade has a hooked edge, and wherein the actuator is configured such that the first blade and the second blade are not capable of simultaneously extending from the first end of the housing.
